(19) United States
(12) Patent Application Publication
(10) Pub. No.: US 2008/0081130 A1
(43) Pub. Date: Apr. 3, 2008

(54) TREATMENT OF EFFLUENT IN THE DEPOSITION OF CARBON-DOPED SILICON

(75) Inventors: Moretza Farnia, Campbell, CA (US); Mehran Moalem, Cupertino, CA (US)

Correspondence Address: JANAH & ASSOCIATES, P.C., 650 DELANCEY STREET, SUITE 106, SAN FRANCISCO, CA, 94107, US

(73) Assignee: Applied Materials, Inc., Santa Clara, CA (US)

(21) Appl. No.: 11/537,418

(22) Filed: Sep. 29, 2006

(51) Int. Cl. H05H 1/24

(52) U.S. Cl. 427/577

(57) ABSTRACT

A substrate processing apparatus exposes a substrate in a process zone of a process chamber to a plasma of a precursor gas comprising a hydrocarbon gas to deposit carbon-doped silicon on the substrate. An effluent comprising unreacted precursor gas and byproducts from the carbon-doped silicon deposition process is exhausted from the process zone and passed into an effluent treatment zone of an effluent treatment reactor. An additive gas comprising an oxygen-containing gas is added to the effluent treatment zone and a plasma is formed of the effluent and additive gas to treat the effluent to reduce the content of unreacted precursor gas and byproduct in the effluent.

### BACKGROUND

Embodiments of the present invention relate to treatment of an effluent generated in the deposition of carbon-doped silicon.

In the manufacture of electronic circuits and displays in substrate processing chambers, a carbon-doped silicon layer which can be a low k dielectric layer having a dielectric constant of less than 3, is deposited on the substrate. The carbon-doped silicon layer is typically an amorphous and porous silicon-oxy-carbide material which may also include organic molecules. The low k dielectric deposition process uses precursor gases that include silicon-containing gases and hydrocarbon gases. The hydrocarbon precursors, include for example, polycyclic hydrocarbons, polycyclic unsaturated hydrocarbons, alkenes, alkynes arenes and arylenes. The hydrocarbons are typically not fully decomposed in the chamber and these hydrocarbons, as well as their by-products, deposit as greasy liquids and solids in the gas exhaust components of the process chamber. The deposits are especially a problem when the precursor gas contains high boiling point precursors such as terpenes, terpenenes, norbornenes, oligomeric hydrocarbons and particularly unsaturated polycyclic hydrocarbons and their fluorinated counterparts which have boiling points higher than 100° C. The exhaust deposits adversely affect the low k deposition process, degrade the components of the exhaust apparatus, and can also pose serious safety issues. Thus, it is desirable to prevent the buildup of such deposits in the exhaust system.

Several methods have been developed to treat the effluents of substrate processing chambers. For example, the effluent can be treated by heating the effluent gas outside the chamber to burn off undesirable gases. For example, the exhaust lines can be heated to temperatures of up to 150° C., or even to temperatures of 800 to 1100° C. Oxygen can also be added to the effluent to further react with and remove undesirable gases. However, such heating processes only partially alleviate the deposition problem, and may even cause the composition of the unreacted precursor gases and process byproducts to combine into other undesirable hazardous gases. Also, it is often difficult to heat the exhaust systems or lines to high temperatures without significant chamber modifications to maintain operator safety. Furthermore, even these high temperatures are often not effective at cleaning the deposits and leave significant amounts of deposits on the walls of the exhaust lines.

The substrate processing effluent can also be treated in a plasma to reduce the hazardous content of the effluent. For example, U.S. Pat. No. 6,673,323 issued to Bhatnagar et al., entitled “Treatment of Hazardous Gases in Effluent”, which is incorporated by reference herein in its entirety, discloses a gaseous treatment apparatus for treating effluent gases which uses a plasma reactor and adds inert gases and oxygen to the effluent in the reactor. However, such plasma effluent gas treatment processes are designed for treating effluent containing perfluorocarbons gases or other halogen gases and not polycyclic hydrocarbons or polymeric and oligomeric byproducts. The plasma effluent treatment processes for fluorocarbon gases are ineffective when used for unsaturated hydrocarbons and liquids and can even cause further polymerization and clogging of the exhaust lines and poses significant safety threat in operation of tools and abatement units.

Thus it is desirable to have an effluent treatment apparatus capable of treating effluent containing hydrocarbon gases, especially high boiling point hydrocarbon liquids and solids. It is desirable to reduce the level of hazardous and toxic materials in the effluent before releasing it to the environment.

### DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1 is a schematic partial sectional side view of a processing chamber for the deposition of carbon doped silicon;

FIG. 2 is a schematic diagram of a remote microwave chamber for dissociation of precursor gases prior to entering the chamber of FIG. 1;

FIG. 3 is a flowchart of a process control computer program product used in conjunction with the processing chamber of FIG. 1;

FIG. 4 is a simplified diagram of a substrate processing apparatus comprising the process chamber of FIG. 1 and an effluent treatment reactor;

FIG. 5 is a schematic of an embodiment of an effluent treatment reactor with electrodes; and

FIG. 5A is a schematic of another embodiment of an effluent treatment reactor with an inductor antenna.

### DESCRIPTION

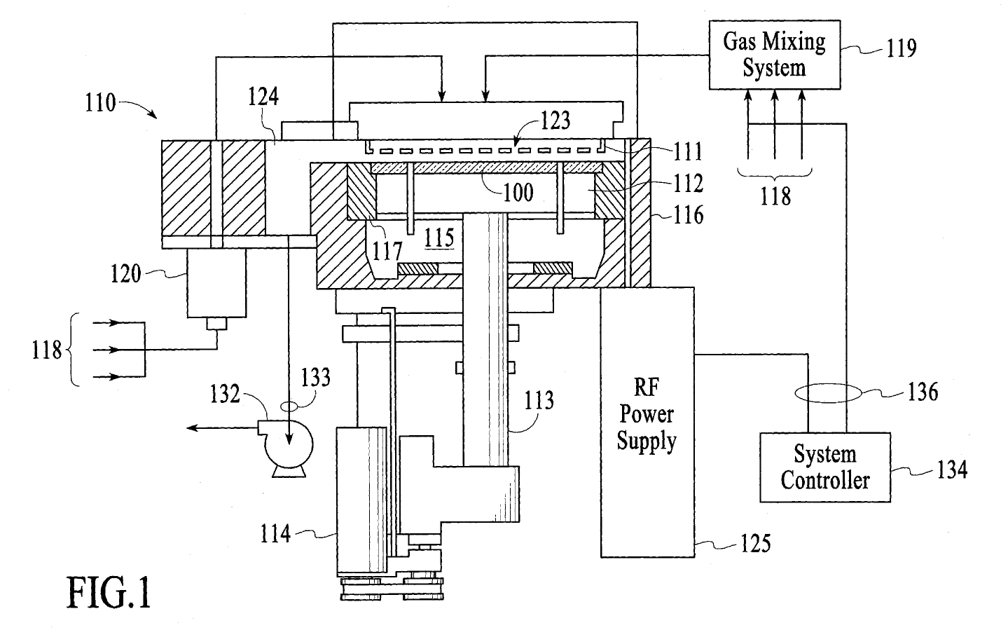

An effluent treatment apparatus can be used to abate effluents formed in the manufacture of electronic circuits and displays in substrate processing chambers, especially when the effluent contains hydrocarbon gases, liquids and solids and halogen-containing oligomers. For example, a substrate fabrication process that generates such effluent is the deposition of carbon-doped silicon material on a substrate. An exemplary process chamber 110 capable of depositing a carbon-doped silicon, such as BLACK DIAMOND™ material, is a CVD plasma chamber such as a “DLK” chamber available from Applied Materials of Santa Clara, Calif. As shown in FIG. 1, the chamber 110 comprises a housing 116 enclosing a process zone 115 capable of maintaining a precursor gas at a low pressure. Typically, any or all of the chamber housing 116 and components in the chamber 110 can be made out of material such as aluminum or anodized aluminum. The particular embodiment of the chamber 110 shown herein, is suitable for processing of substrates 100, such as semiconductor wafers. An example of such a CVD processing chamber is described in U.S. Pat. No. 5,000,113, entitled “Thermal CVD/PECVD Reactor and Use for Thermal Chemical Vapor Deposition of Silicon Dioxide and In-situ Multi-step Planarized Process,” issued to Wang et al. and assigned to Applied Materials, Inc., the assignee of the present invention, which is incorporated by reference herein in its entirety. Another example of such a CVD processing chamber is described in U.S. Pat. No. 6,541,367, entitled “Very Low Dielectric Constant Plasma-Enhanced CVD Films,” issued to Mandal and also assigned to Applied Materials, Inc., the assignee of the present invention, which is also incorporated by reference herein in its entirety. However, it should be noted that the effluent treatment process can be used in any other process chamber as would be apparent to one of ordinary skill in the art.

Referring to FIG. 1, the housing 116 encloses a gas distributor 111 for dispersing precursor gases through perforated holes 123 into the process zone 115. Before reaching the distributor 111, deposition and carrier gases are input through gas lines 118 into a mixing system 119 where they are combined and then sent to manifold 111. A liquid injection system (not shown), such as that typically used for liquid injection of TEOS, may also be provided for injecting a liquid reactant. Preferred liquid injection systems include the AMAT Gas Precision Liquid Injection System (GFLIS) and the AMAT Extended Precision Liquid Injection System (EPLIS), both available from Applied Materials, Inc. Generally, the precursor gases supply lines 118 for each of the precursor gases include (i) safety shut-off valves (not shown) that can be used to automatically or manually shut off the flow of precursor gas into the chamber 110, and (ii) mass flow controllers (also not shown) that measure the flow of gas through the gas supply lines 118. When toxic gases are used in the process, several safety shut-off valves are positioned on each gas supply line 118 in conventional configurations.

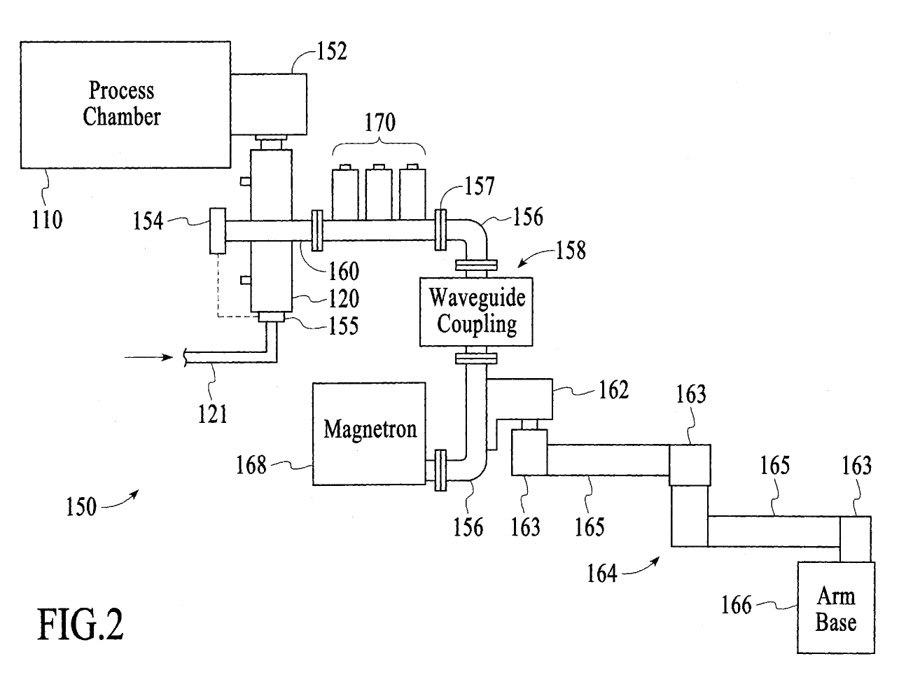

An optional remote microwave system 150, as shown in FIG. 2, having an applicator tube 120 may be located on the input gas line 121 for the oxidizing gas to provide additional energy that dissociates only the oxidizing gas prior to entry to the chamber 110. The microwave applicator 120 provides power from between about 0 and about 6000 W, or even from about 0 to about 3000 W. Separate coupling of the microwave power to activate the gas avoids excessive dissociation of the silicon compounds prior to reaction with the oxidizing gas. Also, a gas distribution plate (not shown) having separate passages for the silicon compound and the oxidizing gas can also be used when microwave power is added to the oxidizing gas.

The microwave system 150 includes an applicator tube 120, a plasma ignition system including an ultraviolet (UV) lamp 154 and a UV power supply 155, a microwave waveguide system that includes various lengths of straight and curved waveguide sections 156, waveguide coupling 158, which may be connected together at joints 157, an output waveguide section 160, and a magnetron 168. The waveguide section 156 may further have an arm support 162 formed therein for attachment to an pivoting arm 164 mounted on an arm base 166. The pivoting arm comprises arm pieces 165 coupled to arm joints 163 that provide vertical separation of the arm pieces and allow rotational movement of the arm 164 around the arm joints 163. The arm joints 163, are vertically disposed cylinders coupled to one arm piece 165 at the bottom of the arm joint 163 and coupled to a second arm piece 165 at the top of the arm joint 165. The arm pieces 165 and arm joint 163 allow vertical separation of the arm pieces and flexibility in positioning arm 164, and thus the microwave system 150, during operation and maintenance of the processing reactor 110.

Magnetron 168 is a typical magnetron source capable of operating between about 0 and about 3000 Watts for continuous wave (CW) or pulsed output of microwaves of about 2.45 Gigahertz (GHz) frequency. Of course, other magnetrons may be utilized as well. A circulator (not shown) allows only forward microwave transmission from magnetron 168 toward applicator tube 120. Tuning system 170, which may use stub tuners or other tuning elements allows matching the load at waveguide section 160 to the characteristic impedance of the waveguides. Tuning system 170 may provide fixed tuning, manual tuning, or automated tuning. In the specific embodiment, the waveguide sections have rectangular cross-sections, but other types of waveguide also may be used.

Applicator tube 120 is a circular (or other cross-section) tube made of a composite or ceramic material, preferably alumina, or other material resistant to etching by radicals. In a specific embodiment, applicator tube 120 has a length of about 18 to 24 inches and a cross-sectional diameter of about 3 to 4 inches. Applicator tube 120 is disposed through a waveguide section 160, which is open at one end for transmitting microwaves and is terminated at the other end with a metal wall. Microwaves are transmitted through the open end of waveguide section 160 to gases inside applicator tube 120, which is transparent to microwaves. Of course, other materials such as sapphire also may be used for the interior of applicator tube 120. In other embodiments, applicator tube 120 may have a metal exterior and an interior made of a composite or ceramic material wherein microwaves in waveguide section 160 enter a window through the exterior of applicator tube 120 to the exposed interior of tube 120 to energize the gases.

The processing that occurs in the chamber 110 includes heating the precursor gases and substrate 100, such as by resistive heating coils (not shown) or external lamps (not shown). Referring back to FIG. 1, substrate support 112 is mounted on a pedestal 113 so that the substrate 100, which is seated within a pocket on the upper surface of the substrate support 112 can be controllably moved between a lower loading/off-loading position and an upper processing position which is closely adjacent to gas distributor 111. The substrate support 112 is raised or lowered by a lift motor 114. The lift motor 114 raises and lowers substrate support 112 between a processing position and a lower, substrate-loading position. The motor 114, the gas mixing system 119, and the RF power supply 125 are controlled by a system controller 134 over control lines 136. The chamber 110 includes analog assemblies, such as mass flow controllers (MFCs) and standard or pulsed RF generators, that are controlled by the system controller 134 which executes system control software stored in a memory 210, which in the preferred embodiment is a hard disk drive. Motors and optical sensors are used to move and determine the position of movable mechanical assemblies such as the throttle valve 133 of the vacuum pump 132 and motor 114 for positioning the substrate support 112. When substrate support 112 and the substrate 100 are in the processing position, they are surrounded by an insulator 117 and precursor gases exhaust into a manifold 124.

The deposition process performed in chamber 110 can be either a non-plasma process on a cooled substrate support 112 or a plasma enhanced process. In a plasma process, a controlled plasma is typically formed adjacent to the substrate 100 by RF energy applied to a plasma generator (not shown) from RF power supply 125 while the substrate support 112 is grounded. Alternatively, RF power can be provided to the substrate support 112 or RF power can be provided to different components at different frequencies. RF power supply 125 can supply either single or mixed frequency RF power to enhance the decomposition of reactive species introduced into the high vacuum region. A mixed frequency RF power supply 125 typically supplies power at a high RF frequency (RF1) of about 13.56 MHz to the distribution manifold 111 and at a low RF frequency (RF2) of about 360 KHz to the substrate support 112. The silicon oxide layers of the present invention are most preferably produced using low levels or pulsed levels of high frequency RF power. Pulsed RF power preferably provides 13.56 MHz RF power at about 20 to about 200 W during about 10% to about 30% of the duty cycle. Non-pulsed RF power preferably provides 13.56 MHz RF power at about 10 to about 150 W as described in more detail below. Low power deposition preferably occurs at a temperature range from about −20 to about 40° C. At the preferred temperature range, the deposited film is partially polymerized during deposition and polymerization is completed during subsequent curing of the film.

The chamber 110 also includes a gas exhaust port 135 to remove the effluent comprising unreacted processing gas and byproducts. A vacuum pump 132 having a throttle valve 133 controls the exhaust rate of gases from the chamber 110.

The system controller 134 controls all of the activities of the CVD chamber and a preferred embodiment of the controller 134 includes a hard disk drive, a floppy disk drive, and a card rack. The card rack contains a single board computer (SBC), analog and digital input/output boards, interface boards and stepper motor controller boards. The system controller 134 conforms to the Versa Modular Europeans (VME) standard which defines board, card cage, and connector dimensions and types. The VME standard also defines the bus structure having a 16-bit data bus and 24-bit address bus.

To facilitate control of the chamber 110 as described above, the controller 134 embodied in a CPU 220 may be one of any form of general purpose computer processor that can be used in an industrial setting for controlling various chambers and subprocessors. The memory 210 is coupled to the CPU 220, and is accessible to the system bus 230. The memory 210, or mass storage device 215, may be one or more of readily available memory such as random access memory (RAM), read only memory (ROM), floppy disk drive, hard disk, or any other form of digital storage, local or remote. The support circuits (not shown) are coupled to the CPU 220 for supporting the processor 220 in a conventional manner. The deposition process is generally stored in the memory 210, typically as a software routine. The software routine may also be stored and/or executed by a second CPU (not shown) that is remotely located from the hardware being controlled by the CPU 220.

The memory 210 contains instructions that the CPU 220 executes to facilitate the performance of the processing system 10. The instructions in the memory 210 are in the form of program code such as a program 200 that implements the method of the present invention. The program code may conform to any one of a number of different programming languages. For example, the program code can be written in C, C++, BASIC, Pascal, or a number of other languages.

The mass storage device 215 stores data and instructions and retrieves data and program code instructions from a processor readable storage medium, such as a magnetic disk or magnetic tape. For example, the mass storage device 215 can be a hard disk drive, floppy disk drive, tape drive, or optical disk drive. The mass storage device 215 stores and retrieves the instructions in response to directions that it receives from the CPU 220. Data and program code instructions that are stored and retrieved by the mass storage device 215 are employed by the processor unit 220 for operating the processing system. The data and program code instructions are first retrieved by the mass storage device 215 from a medium and then transferred to the memory 210 for use by the CPU 220.

The input control unit 245 couples a data input device, such as a keyboard, mouse, or light pen, to the processor unit 220 via the system bus 230 to provide for the receipt of a chamber operator's inputs. The display unit 255 provides information to a chamber operator in the form of graphical displays and alphanumeric characters under control of the CPU 220.

The control system bus 230 provides for the transfer of data and control signals between all of the devices that are coupled to the control system bus 230. Although the control system bus 230 is displayed as a single bus that directly connects the devices in the CPU 220, the control system bus 230 can also be a collection of busses. For example, the display unit 255, input control unit 245 (with input device), and mass storage device 215 can be coupled to an input-output peripheral bus, while the CPU 220 and memory 210 are coupled to a local processor bus. The local processor bus and input-output peripheral bus are coupled together to form the control system bus 230.

The system controller 134 is coupled to the elements of the processing system 220, employed in dielectric deposition processes in accordance with the present invention via the system bus 230 and the I/O circuits 240. The I/O circuits 240 receive instructions from the program 200 stored in memory 210 via the CPU 220 and system bus 230. The program 200 provides program subroutines that enable the I/O circuits 240 to provide for substrate positioning control 250, precursor gas control 260, pressure control 270, heater control 280, and plasma/microwave control 290, of the chamber 110, and effluent treatment control 292 which controls the effluent treatment apparatus described below.

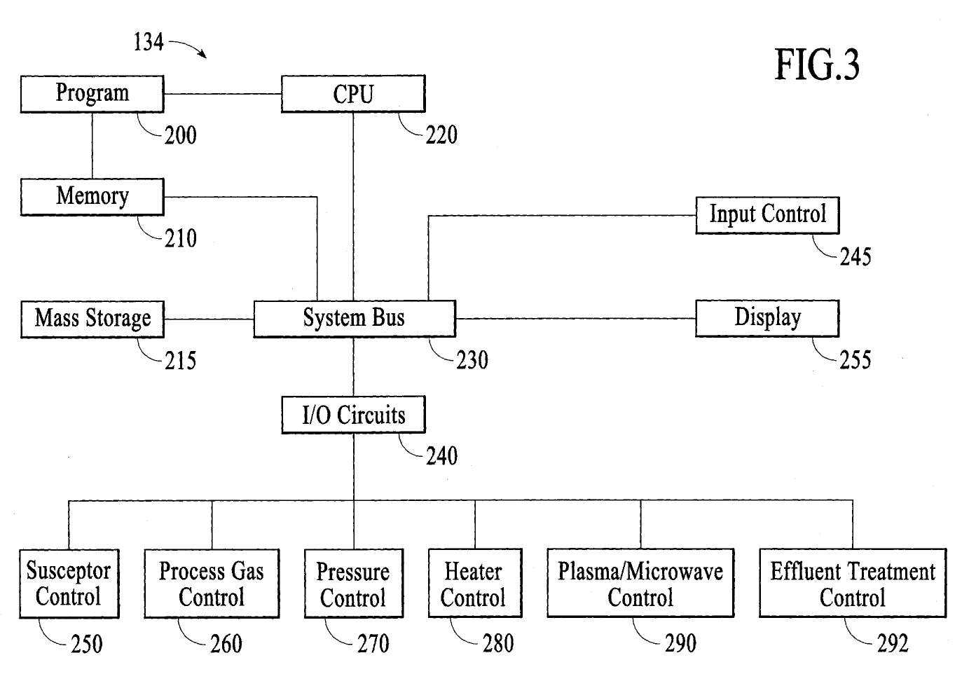

The CPU 220 forms a general purpose computer that becomes a specific purpose computer when executing programs such as the program 200 of the embodiment of the method of the present invention depicted in the flow diagram of FIG. 3. Although the invention is described herein as being implemented in software and executed upon a general-purpose computer, those skilled in the art will realize that the invention could be implemented using hardware such as an application specific integrated circuit (ASIC) or other hardware circuitry. As such, it should be understood that the invention can be implemented, in whole or in part, in software, hardware or both.

The processing chamber 110 as described above is provided only to illustrate the invention, and should not be used to limit the scope of the invention. It will be appreciated that other suitable processing chambers can be used as well. The above CVD processing chamber description is mainly for illustrative purposes, and other plasma CVD equipment such as electrode cyclotron resonance (ECR) plasma CVD devices, induction-coupled RF high density plasma CVD devices, or the like may be employed. Additionally, variations of the above described system such as variations in substrate support design, heater design, location of RF power connections and others are possible. For example, the substrate could be supported and heated by a resistively heated substrate support. The pretreatment and method for forming a pretreated layer of the present invention is not limited to any specific apparatus or plasma excitation method. The use of other apparatuses may be utilized while remaining within the scope of the invention.

Depositing a layer of carbon-doped silicon on a substrate 100 is described, for example, in U.S. Pat. No. 6,610,354 issued to Law et al., entitled “Plasma Display Panel with a Low k Dielectric Layer”, which is incorporated by reference herein in its entirety. A carbon-doped silicon layer is deposited on a substrate by first loading a substrate 100 into the processing chamber 110 through a vacuum interlock (not shown) and placing the substrate 100 onto a substrate support 112 in the chamber 110. Once the substrate 100 is properly positioned, the temperature of the substrate 100 and chamber 110 are controlled so as to maintain a processing temperature of for example, from about 0° C. to about 250° C.

Next, a precursor gas is introduced into the chamber 110 and then an RF power component (not shown) is applied to the precursor gas to form a plasma. The precursor gas is introduced into the processing chamber 110 from a gas distributor 111. The precursor gases include trimethylsiliane (TMS) or methylsilane (MS) or a combination of these precursors, along with an oxygen precursor gas. In some embodiments, the precursor gas also includes an inert gas such as a gaseous source of helium (He) or argon (Ar). TMS or MS or a combination of TMS and MS is introduced into the processing chamber 110 at a flow rate of about 30-150 sccm and either O₂, O₃, N₂O or some combination thereof is introduced at a flow rate of about 300-1500 sccm. Those skilled in the art recognize that the gases can be flowed sequentially or simultaneously and that the flow rates scale with the size of the chamber being used and the surface area of the substrate upon which the film is to be deposited. In addition, helium (He) may be may be introduced as a carrier gas. If used, He will be introduced into the processing chamber 110 at a rate of about 1500-8000 sccm. Generally, the gas flow rates are set such that a ratio of the sum of the flow rates of the gaseous sources of oxygen divided by the sum of the flow rates of TMS and MS will be about 2 to 50, usually about 5 to 40. If used, the ratio of He flow to the sum of the flow rates of TMS and MS will be about 10 to 260, usually about 30 to 75.

The chamber 110 is maintained at a pressure of about 1-15 Torr and the precursor gas is excited into a plasma state through the use of an RF power source 125 which generates a power density of about 0.10 to 0.25 W/cm². The deposition rate of the process will be at least about 350 nanometers per minute, for a flow ratio, defined by the flow rate of gaseous sources of oxygen divided by the sum of the flow rates of TMS and MS of about 10. The duration of the flow of precursor gases will be determined by the desired thickness of the layer to be deposited. After deposition of the layer, the RF power 125 is turned off, the gas flow into the chamber 110 is stopped and the gases in the chamber 110 are pumped out of the chamber 110 to form an effluent gas. The result of this process is a stable carbon-doped silicon layer having a thickness of about 10 to 15 microns having a dielectric constant of less than about 3.5, and usually between about 2.6 to 3.4. It is understood that the processing gases can be flowed concurrently or serially. It is noted that a capping layer may be omitted for a carbon-doped silicon dielectric layer.

In one example, the chamber 110 is used to deposit a carbon-doped silicon layer on a substrate 100 while the chamber 110 is maintained at a temperature of about 25° C. after loading the substrate. Methylsilane is flowed into the chamber 110 at about 117 sccm, N₂O at about 1,235 sccm, and He gas at about 6,800 sccm. The pressure in the chamber 110 is controlled to about 3 Torr and an RF power of about 275 W used to generate the plasma for forming the carbon-doped silicon deposition layer. Processing will proceed for about 25 to 45 minutes to form a deposition layer of about 10 to 15 microns in thickness.

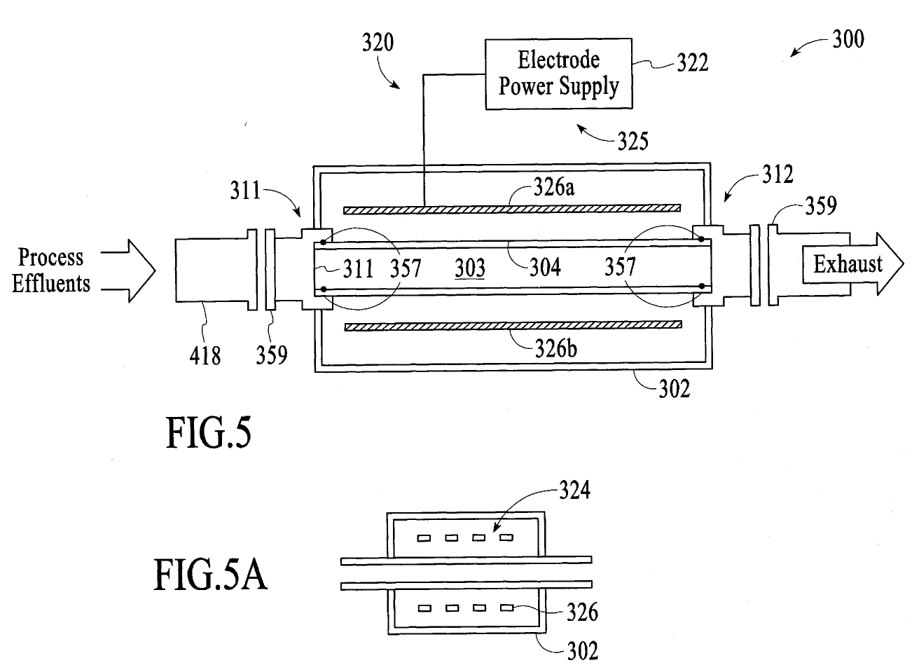

The effluent generated by the carbon-doped silicon process is treated in an effluent treatment reactor 300. While the effluent treatment reactor 300 is described in the context of the deposition of carbon-doped silicon, it should be understood that the effluent treatment reactor 300 can be used with other substrate fabrication processes and chambers. An exemplary effluent treatment reactor 300, as illustrated in FIG. 5, comprises an enclosure 302 having an inlet 311 connected to an exhaust port 135 of the process chamber 110 to pass effluent generated in the process chamber 110 to the reactor 300 through gas line 418. Gas line 418 connects to and inlet 311 and an outlet 312 of the reactor 300 with O-rings 357. A vacuum flange 359 is located in the forline 418 before the inlet 311 and after the outlet 312.

The enclosure 302 has an effluent treatment zone 303, which is composed of a gas impermeable material, such as a ceramic or metal material. In one version, the enclosure 302 is a cylinder 304 comprising a ceramic material such as quartz (silicon dioxide) or polycrystalline aluminum oxide (Al₂O₃). The cylinder 304 has sufficient strength to withstand operating vacuum type pressures of 10⁻⁵ Torr. The cylinder 304 can have a diameter of at least about 5 mm, or even at least about 35 mm. Advantageously, the cylinder 304 can be linearly oriented to the direction of flow of effluent through the reactor 300 to reduce possible backflow of effluent that can occur through obstructions of the effluent path through the reactor 300. Thus, the cylinder 304 has a longitudinal central axis that is oriented parallel to the direction of the flow path of effluent. The length of the reactor 300 is sufficiently long to allow the effluent to remain resident in the cylinder 304 for a sufficient time to abate substantially all of the hazardous gas content of the effluent. The precise length of the reactor 300 depends on a combination of factors including the diameter of the exhaust tube (not shown), the composition and peak flow rate of the effluent, and the power level applied to the abatement plasma. For an effluent comprising aromatic hydrocarbons oligomers such as terpenenes at total flow of about 1000 sccm, a sufficient resident time is at least about 0.01 seconds, or even about 0.1 seconds. A suitable length of reactor 300 that provides such a residence time, comprises a cylindrical tube 304 having a cross-sectional diameter of 35 mm, and a length of from about 20 cm to about 50 cm.

In one version, a bypass valve 318 may be provided in or near the reactor 300 to control the flow of effluent into, or to bypass, the reactor 300. The throttle valve 318 may optionally be under the control of the controller 134. The bypass valve 318 is a safety feature and can also be used to redirect the effluent gas flow to avoid the reactor 300.

The reactor 300 receives additive gas from additive gas source 335. The additive gas source 335 is connected to the reactor 300 via gas line 418. Optionally, the reactor 300 may include the additive gas source 335 connected directly to reactor 300 by a conduit (not shown) and the flow of gas could be controlled with a control valve (not shown). The operation of the control valve may be under the control of a controller 134, as will be described, or may be operated by hand.

The additive gas source 335 provides an additive gas to the effluent gas, before, or as after the effluent is energized, to enhance abatement of the hazardous gas emissions. When energized, the additive gas dissociates or forms energized species that react with the energized hazardous gas species to create gaseous compounds that are non-toxic, or soluble and easily removed by a wet scrubber located downstream in the exhaust apparatus 300. The addition of even a small amount of additive gas to the effluent gas can significantly improve abatement efficiency.

In one example, the additive gas comprises an oxygen-containing gas, such as O₂ and O₃. The oxygen-containing gas combines with the effluent in the exhaust tube (not shown) or in the reactor 300. In the reactor 300, the effluent and the additive gas are energized as described above. Disassociated hazardous gases, such as terpenenes and their oligomers are oxidized in the plasma and converted to reaction products, such as CO₂, CH₄, HF, C₃H₆ and H₂0, that are exhaustible or are treatable for safe exhaustion. For example, CO₂ can be safely exhausted and HF can be scrubbed and dissolves in water. It should be understood the other additive gases such as oxygen plasma, hydrogen plasma and water plasma having various plasma powers and flow rates may also be used to effectively break down the energized hazardous gas species.

It has been discovered that by properly selecting the volumetric flow ratio of reactive gas to hazardous gas in the effluent, the hazardous gas reduction efficiency can be substantially improved by an unexpected amount. For example, it has been discovered that when using an additive gas comprising an oxygen-containing gas the volumetric flow ratio of oxygen atoms in the additive gas to carbon atoms in the effluent 100 should be at least about 1.8:1. In one version, the volumetric flow rate of the oxygen-containing gas may be determined by comparing the stoichiometric formula of the oxygen-containing gas to the stoichiometric formula or formulae of the hydrocarbon gas or gases. A factor can be calculated by dividing the sum of the number of carbon atoms and ½ of hydrogen atoms in the hydrocarbon formula by the number of oxygen atoms in the oxygen-containing gas formula and multiplying the result by 2. This factor can then be used to determine the minimum oxygen-containing gas volumetric flow rate by multiplying the volumetric flow rate of the hydrocarbon gas by the factor.

For example, when the additive gas comprises O₂, the volumetric flow rate of the O₂ is determined by multiplying the volumetric flow rate of the hydrocarbon gas by the appropriate factor to reach an oxygen atom to carbon atom in the effluent ratio of at least about 1.8:1. For example, for single-carbon hydrocarbons, such as CH₄, the volumetric flow rate of O₂ is at least about 2 times the volumetric flow rate of the CH₄. For hydrocarbons containing two carbon atoms, such as C₂H₆, the volumetric flow rate of O₂ is at least about 2.5:1. In another version, the reactive gas in the additive gas comprises ozone, O₃. Since ozone contains three oxygen atoms, the minimum volumetric flow ratio of ozone to carbon atoms in the effluent for the case of CH₄ is 1.33:1.

In instances when the effluent gas comprises more than one type of hydrocarbon gas, the minimum flow rate of the reactive gas is determined by summing the minimum flow rates of reactive gas associated with each constituent of hydrocarbon gas. For example, in an effluent comprising 100 sccm of Alpha-Terpenene and 50 sccm of mDEOS, the additive comprising O₂ can be introduced at a flow rate of at most about (14)(100 sccm)+(8.5)(50 sscm), or about 1825 sccm oxygen or 912.5 sccm O2. At the optimum condition, at least 730 sccm O2 can be used because about half the carbon is partially oxidized to CO instead of CO₂.

The effluent treatment apparatus 300 further comprises a gas energizer 322. The gas energizer 322 may, in one version, inductively or capacitively couple RF energy to the effluent to form charged ionized species in the reactor 300. In the embodiment shown in FIGS. 5 and 5A, the gas energizing system 320 comprises a gas energizer power supply 325 and an inductor antenna 324 around or adjacent to the reactor 300. The power supply 325 may comprise an RF energy coupling system including RF source and RF match network circuits that supplies a gas energizing RF voltage to the antenna 324 to form an energized gas or plasma in the reactor chamber 300. In an alternative arrangement, such as the one shown in FIG. 5A, a pair of electrodes 326a,b can be positioned in the reactor 300 (as shown) or outside the reactor 300 (not shown) and acting on gas through a dielectric barrier. The gas energizing system 320 in this embodiment comprises a gas energizer power supply 325 that applies an RF bias voltage to one of the electrodes 326a and the other electrode 326b is maintained at a different potential, such as ground, in order to capacitively couple the electrodes 326a,b. The gas energizer 322 can also be a microwave coupling system similar to the one used on the process chamber 110, or an adaptation of the same.

The energy applied to the effluent and additive gas is carefully controlled so that the RF radiation raises the energy of some electrons of the atoms of the effluent gas molecules to energies from 1 to 10 eV, thereby freeing electrons and breaking the bonds of the gas molecules to form dissociated atomic gaseous species. In an energized plasma gas, avalanche breakdown occurs in the gaseous stream when the individual charged species electrons and charged nuclei are accelerated in the prevalent electric and magnetic fields to collide with other gas molecules causing further dissociation and ionization of the effluent gas. The ionized or dissociated gaseous species of the energized effluent react with each other, or with other non-dissociated gaseous species, to form non-toxic gases or gases that are highly soluble in conventional gas scrubbers. For example, hydrocarbon containing effluent may be mixed with an oxygen-containing gas, such as O₂ gas, and passed through the reactor 215. The gas 101 exiting the gas energizing reactor 210 has been determined to have a greater than about a 95 percent reduction of the hydrocarbon gases from the effluent 100. Preferably, the effluent and additive gas are energized at a plasma power level of at least about 1200 watts, or even from about 100 to about 3000 watts.

Substrate processing apparatus 101 further comprises an infrared sensor 400 which is capable of generating a signal upon detection of an infrared signature of a hydrocarbon gas in the effluent 400. An infrared sensor is described, for example, in U.S. Pat. No. 6,366,346 issued to Nowak et al., entitled “Method and Apparatus for Optical Detection of Effluent Composition”, which is incorporated by reference herein in its entirety. The infrared sensor 400 is located outside of a window in the gas line 418 between the gas exhaust port 135 of the process chamber 110 and the gas inlet 311 of the effluent treatment reactor 300. The infrared sensor 400 is capable of generating a signal upon detection of an infrared signature of a hydrocarbon gas in the effluent. This signal is then sent to the controller 134 which activates the gas energizer 322. In one version, the infrared sensor 400 is capable of detecting an infrared signature corresponding to hydrocarbon oligomers or Alpha Terpenene or fluorinated counterparts.

The sensor 400 detects the light emitted by the plasma and converts it into a voltage signal. The light emitted by the plasma indicates the types and concentrations of gases in the plasma because different gases will emit different wavelengths of light when excited in a plasma and the amplitude of a detected wavelength provides an indication of the amount or concentration of a particular gas in the effluent stream. The sensor can be any of a number of optical detectors, such as a phototransistor or photodiode. Although desirable in order to simplify data interpretation, it is not necessary for the sensor response to be linear. The sensor can also include various lens or filters as would be apparent to one of ordinary skill in the art. For example, a suitable filter is a band-pass filter centered at the infrared wavelength of interest. A suitable infrared sensor is a Perkin-Elmer model TPS434 NDIR gas analysis IR sensor in conjunction with correct bandpass infrared filter such as Barr Associates bandpass filter for 3-8.5 micrometer wavelength.

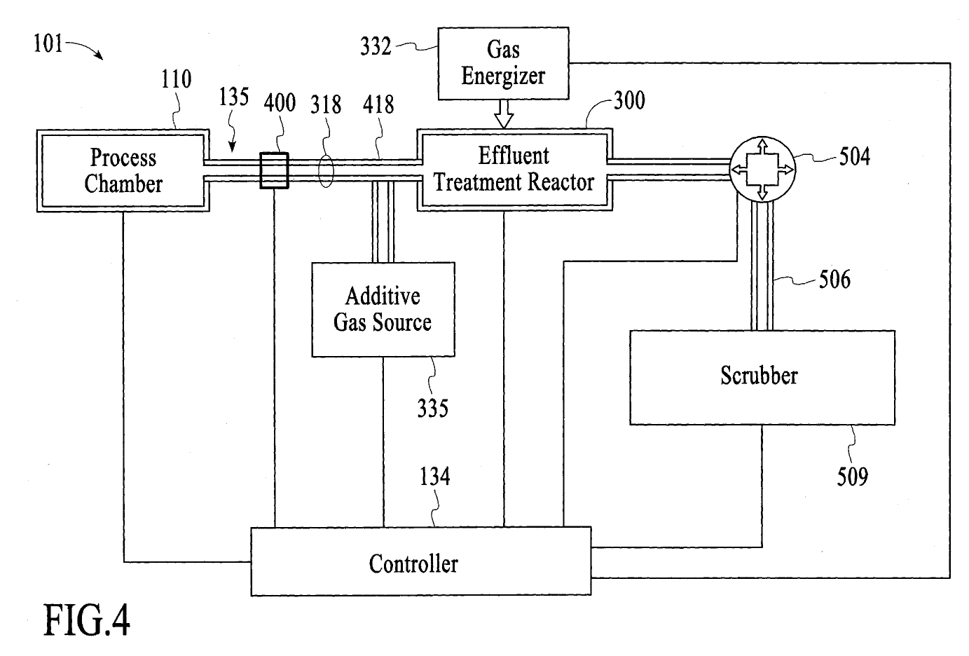

The controller 134 is used to operate both the process chamber 110 and the effluent treatment reactor 300 of the substrate processing apparatus 101, as shown in FIG. 3. The controller 134 comprises electronic hardware including integrated circuits that are suitable for operating both the process chamber 110 and the effluent treatment reactor 300. The controller 134 is adapted to accept data input, run algorithms, produce date output signals, detect data signals from sensors and other chamber components, and monitor process conditions within the substrate processing apparatus 101 (FIG. 4). The controller 134 comprises effluent treatment control 192 instruction sets which has program code to receive a signal from the infrared sensor 400 and activate the gas energizer 322 of the effluent treatment reactor 300 when the signal indicates that hydrocarbon is present in the effluent. The effluent treatment control 292 also has safety code to turn off the effluent treatment reactor should unsafe conditions occur or be measured. The program code to activate the gas energizer 322 controls the power supply which applies power to for example, the electrode or coil of the gas energizer.

A scrubber 509 containing a scrubbing fluid such as H₂O, can be provided in the apparatus 101. The scrubbing fluid provided in the scrubber can convert reaction products in the abated effluent exiting from the process pump 504 and traveling through exhaust line 506 to exhaustible product.

The effluent treatment reactor 300 and gas treating process are successful in reducing the hazardous gas content of an effluent by at least about 90% in a well controlled and consistent manner. The effluent treatment reactor 300 may be a self-contained and integrated unit that is compatible with various process chambers 110. The effluent treatment reactor 300 can be used to reduce a large variety of hazardous gases, including substantially all types of hydrocarbons. The effluent treatment reactor 300 has no impact on process chamber 110 operation and may be used with any process chamber that exhausts hazardous gases. The plasma abatement apparatus is convenient to handle and occupies less than 3 cubic feet for treating effluent from a single process chamber 110 and less than 40 cubic feet for treating effluent from multiple process chambers.

Although the present invention has been described in considerable detail with regard to certain preferred versions thereof, other versions are possible. For example, the additive gas source 335 and the gas energizers 322 may be interchangeable with each other. Also, the reactor 300 of the present invention can be used in other chambers and for other processes, such as physical vapor deposition and etching chambers. Therefore, the appended claims should not be limited to the description of the preferred versions contained herein.

1. A method of depositing carbon-doped silicon and treating an effluent comprising unreacted precursor gas and byproducts from the carbon-doped silicon deposition process, the method comprising:
(a) depositing carbon-doped silicon by exposing a substrate in a process zone to a plasma of a precursor gas comprising a hydrocarbon gas and a silicon-containing gas;
(b) exhausting from the process zone, an effluent comprising unreacted precursor gas and byproducts from the carbon-doped silicon deposition process;
(c) passing the effluent to an effluent treatment zone;
(d) introducing an additive gas comprising an oxygen-containing gas into the effluent treatment zone; and
(e) forming a plasma of the effluent and additive gas in the effluent treatment zone to treat the effluent to reduce the content of unreacted precursor gas and byproduct of the carbon-doped silicon deposition process in the effluent.

2. A method according to claim 1 wherein in (b), the hydrocarbon gas comprises cumene.

3. A method according to claim 1 wherein in (b), the precursor gas comprises cyclohexadiene.

4. A method according to claim 1 wherein the effluent comprises alpha-terpenene, and the additive gas comprises an oxygen-containing gas so that the ratio of oxygen atoms in the additive gas to carbon atoms in the effluent gas is at least about 1.33:1.

5. A method according to claim 1 wherein the additive gas comprises a halogen containing gas.

6. A method according to claim 1 wherein the additive gas comprises O₂.

7. A method according to claim 1 wherein the additive gas further comprises an inert or non-reactive gas.

8. A method according to claim 7 wherein the additive gas further comprises an inert gas so that the volumetric flow ratio of inert gas to oxygen-containing gas is 2.

9. A method according to claim 1 wherein in (e), the plasma power level is at least about 1200 watts.

10. A method according to claim 1 wherein in (e), the plasma power level is from about 100 to about 3000 watts.

11. A method according to claim 1 comprising performing steps (d) and (e) only when a presence of the hydrocarbon precursor in the effluent is detected.

12. A method according to claim 11 comprising detecting the presence of the hydrocarbon precursor by an infrared signature of the hydrocarbon precursor.

13. A substrate processing apparatus capable of depositing carbon-doped silicon and treating an effluent comprising unreacted precursor gas and byproducts from the carbon-doped silicon deposition process, the apparatus comprising:
(a) a process chamber comprising a housing enclosing a substrate support, a gas distributor to introduce a precursor gas into the housing, a plasma generator to form a plasma of the precursor gas, and a gas exhaust port to remove effluent comprising unreacted precursor gas and byproducts from the housing;
(b) an effluent treatment reactor comprising:
(i) an enclosure having an inlet to receive the effluent from the gas exhaust port of the process chamber,
(ii) an additive gas port through which an additive gas can be provided to the enclosure; and
(iii) a gas energizer to energize the effluent and additive gas in the enclosure;
(c) an infrared sensor capable of generating a signal upon detection of an infrared signature of a hydrocarbon gas in the effluent, the infrared sensor located outside of a window in a gas line between the gas exhaust port of the process chamber and the gas inlet of the effluent treatment reactor;
(d) a controller to operate the process chamber and effluent treatment reactor, the controller comprising effluent treatment control program code to receive the signal from the infrared sensor and activate the gas energizer of the effluent treatment reactor when the signal indicates that hydrocarbon is present in the effluent.

14. An apparatus according to claim 13 wherein the infrared sensor is capable of detecting an infrared signature corresponding to hydrocarbon oligomers or Alpha Terpenene or fluorinated counterparts.

15. An apparatus according to claim 13 wherein the gas energizer inductively or capacitively couples RF energy to the effluent.

16. An apparatus according to claim 13 wherein the enclosure comprises a ceramic.

17. An apparatus according to claim 16 wherein the ceramic is an Al₂O₃ cylinder.

18. A method according to claim 1 wherein the additive gas further comprises at least one of:
(i) an oxygen-containing gas comprising O₂;
(ii) a halogen containing gas;
(iii) an inert gas; and
(iv) a non-reactive gas.
